(19) United States
(12) Patent Application Publication
(10) Pub. No.: US 2013/0240064 A1
(43) Pub. Date: Sep. 19, 2013

(54) HYDRATION PACK

(71) Applicant: CHIEN-PING LIEN, New Taipei City (TW)

(72) Inventor: CHIEN-PING LIEN, New Taipei City (TW)

(21) Appl. No.: 13/420,313

(22) Filed: Mar. 14, 2012

(51) Int. Cl. F03B 11/00; F16L 37/08

(52) U.S. Cl. 137/561 R; 285/319

(57) ABSTRACT

A hydro pack includes a water bag for receiving liquid therein and a water withdrawing device is connected to the water bag. The water withdrawing device includes a base fixed to the water bag and a connection unit. The connection unit has two resilient plates located on two sides thereof. Each resilient plate has a first end fixed to the connection unit and a second end of each resilient plate is a curved end and extends outward. A protrusion protrudes from the outside of each resilient plate. The connection unit is inserted into the base which has holes with which the two protrusions on the two resilient plates are engaged. The water withdrawing device is easily assembled to and removed from the water bag, and is easily cleaned.

### FIELD OF THE INVENTION

The present invention relates to a hydro pack, and more particularly, to a hydro pack with a water bag and a water withdrawing device which is firmly connected to the water bag and easily cleaned.

### BACKGROUND OF THE INVENTION

The conventional hydro packs are more welcomed along with the increase of the outdoor activities, and the hydro pack generally comprises a water bag and a water withdrawing device which includes a base and a connection unit which has a threaded section so as to be threadedly connected to the threads in the base. However, there are gaps defined between the threads of the base and the threads of the threaded section of the connection unit, so that water may leaks from the gaps. Besides, the connection by threading for the base and the connection unit requires time to assemble or dis-assemble, and the connection cannot bear pulling force so that strength of the conventional hydro packs needs to be reinforced.

The present invention intends to provide a hydro pack wherein the connection between the water withdrawing device is firmly connected to the water bag, and the water withdrawing device is easily removed from the water bag and is easily cleaned.

### SUMMARY OF THE INVENTION

The present invention relates to a water withdrawing device for a water bag and the water withdrawing device comprises a base fixed to the water bag and a connection unit. The connection unit has two resilient plates located on two sides thereof. Each resilient plate has a first end fixed to the connection unit and a second end of each resilient plate is a curved end and extends outward. Each resilient plate has a protrusion on the outside thereof. The base has holes with which the two protrusions on the two resilient plates are engaged.

Preferably, two boards extend from the connection unit and are located alternatively to the resilient plates. The base has two slots with which the two boards are engaged.

Preferably, the connection unit has a groove defined in the outside of the first end thereof and a seal ring is engaged with the groove. The first end of the connection unit is inserted into the base and the seal ring seals the inner periphery of the base.

Preferably, threads are defined in the outside of the second end of the connection unit.

The present invention also provides a hydro pack and comprises a water bag for receiving liquid therein and a water withdrawing device is connected to the water bag. The water withdrawing device comprises a base fixed to the water bag and a connection unit. The connection unit has two resilient plates located on two sides thereof. Each resilient plate has a first end fixed to the connection unit and a second end of each resilient plate is a curved end and extends outward. Each resilient plate has a protrusion on the outside thereof. The base has holes with which the two protrusions on the two resilient plates are engaged.

Preferably, two boards extend from the connection unit and are located alternatively to the resilient plates. The base has two slots with which the two boards are engaged.

Preferably, the connection unit has a groove defined in the outside of the first end thereof and a seal ring is engaged with the groove. The first end of the connection unit is inserted into the base and the seal ring seals the inner periphery of the base.

Preferably, threads are defined in the outside of the second end of the connection unit.

The primary object of the present invention is to provide a water withdrawing device which is assembled to a water bag and can be easily removed from the water bag and is easily cleaned.

Another object of the present invention is to provide a water withdrawing device which is connected to a water bag and more durable than the conventional water withdrawing devices.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the water withdrawing device of the present invention;

FIG. 2 is another exploded view to show the water withdrawing device of the present invention, wherein the base and the connection unit are partially removed;

FIG. 3 is a cross sectional view to show the connection of the base and the connection unit;

FIG. 4 is another cross sectional view to show the connection of the base and the connection unit, and

FIG. 5 shows that the water withdrawing device of the present invention is connected to a water bag, and a hose with a valve is connected to the connection unit.

### DETAILED DESCRIPTION OF THE PREFERRED EMBODIMENT

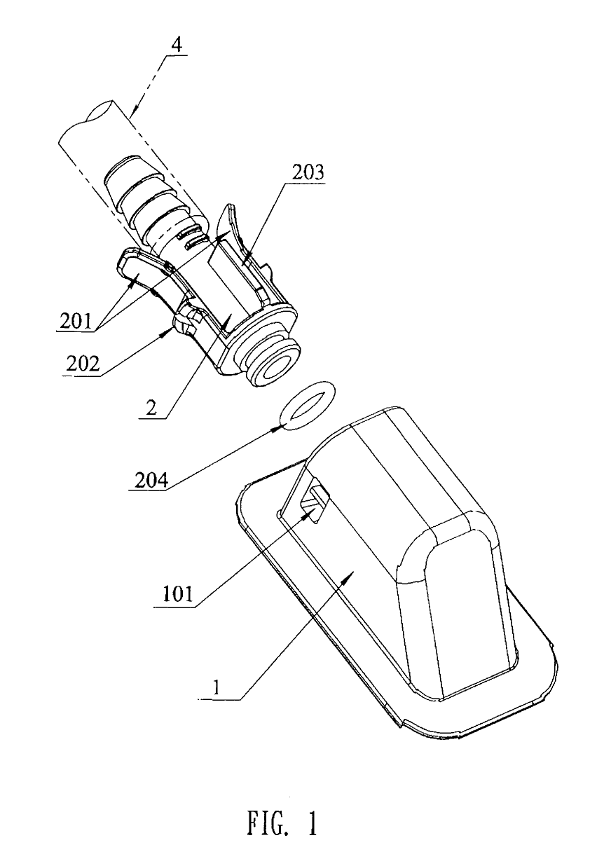

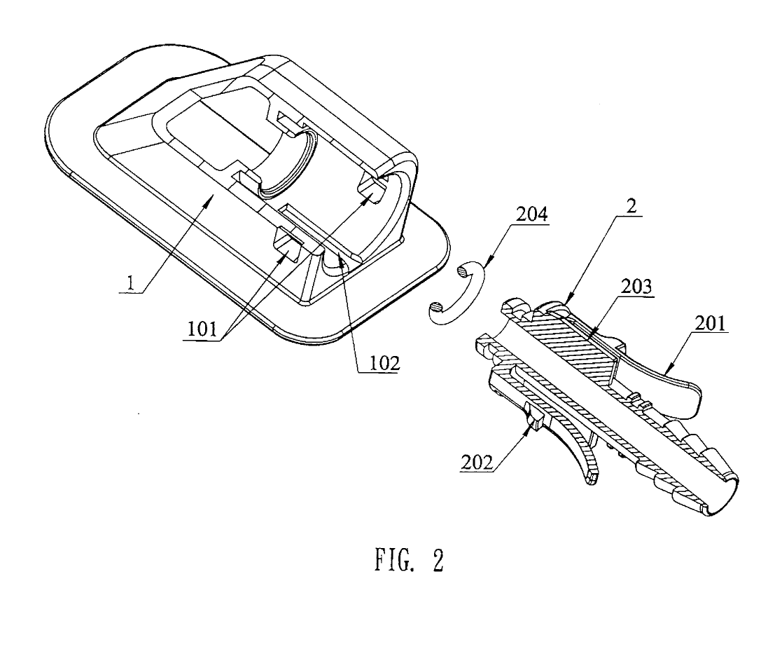

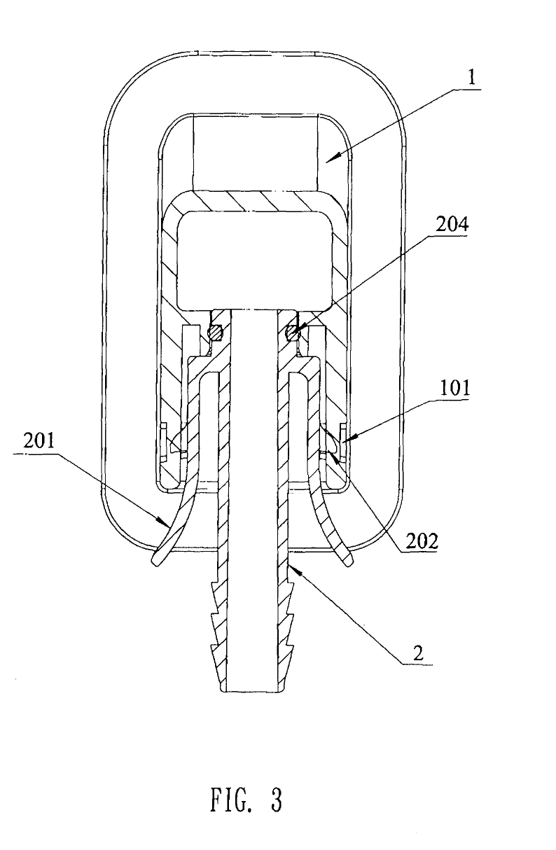

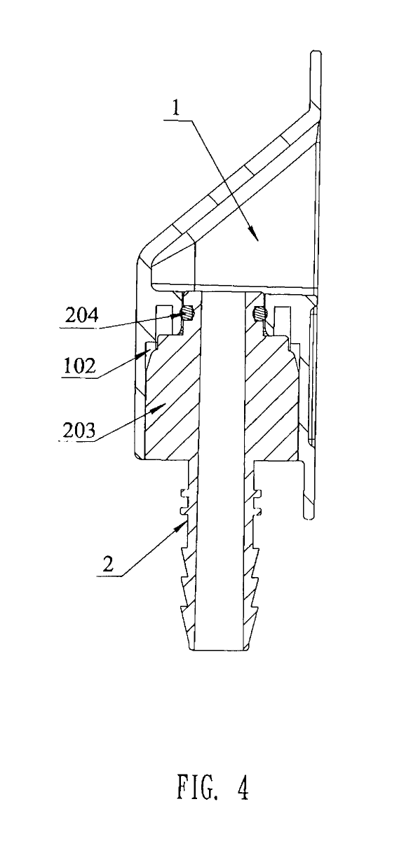

Referring to FIGS. 1 to 4, the water withdrawing device of the present invention comprises a base 1 and a connection unit 2 which has a connection mechanism located at the first end thereof and the first end of the connection unit 2 is connected to the base 1 by the connection mechanism. The base 1 is fixed to a water bag and the connection mechanism comprises two resilient plates 201 located on two sides of the connection unit 2. Each resilient plate 201 has a first end fixed to the connection unit 2 and a second end of each resilient plate 201 is a curved end and extends outward. Each resilient plate 201 has a protrusion 202 on the outside thereof. The base 1 has a reception recess for receiving the first end of the connection unit 2 and two holes 101 are defined through the wall of the reception recess so that the two protrusions 202 on the two resilient plates 201 are engaged with the holes 101. When assembling, the two resilient plates 201 can be pushed inward so that the first end of the connection unit 2 is inserted into the reception recess of the base 1. When releasing the resilient plates 201, the two protrusions 202 on the two resilient plates 201 are engaged with the holes 101 to connect the connection unit 2 to the base 1. The connection between the base 1 and the connection unit 2 is more durable and strong than the conventional threaded connection. When disassembling the connection unit 2 from the base 1, the user pushes the two protrusions 202 inward so that the two protrusions 202 are removed from the holes 101, and the connection unit 2 can be removed from the base 1. Therefore, the connection unit 2 and the base 1 can be easily cleaned.

There are two boards 203 extending from the connection unit 2 and the two boards 203 are located alternatively to the resilient plates 201. The base 1 has two slots 102 defined through the wall of the reception recess and the two boards 203 are removably engaged with the two slots 102. The connection between the boards 203 and the two slots 102 ensures that the connection unit 2 and the base 1 are more reliable and secured. The base 1 is a casing and the outlet of the water bag is a circular hole and defined in the casing. The first end of the connection unit 2 is a hollow and tubular portion which is engaged with the outlet so that the liquid in the water bag flows to the connection unit 2 via the outlet. The connection unit 2 has a groove defined in the outside of a first end thereof and a seal ring 204 is engaged with the groove. The first end of the connection unit 2 is inserted into the base 1 and the seal ring 204 seals the inner periphery of the outlet of the base 1. There are threads are defined in the outside of a second end of the connection unit 2 and a hose 4 can be securely mounted to the threads so as to be connected with the connection unit 2.

When installing the connection unit 2 to the base 1, the user pushes the two resilient plates 201 inward and the first end of the connection unit 2 is inserted into the reception recess of the base 1. When releasing the resilient plates 201, the two protrusions 202 on the two resilient plates 201 are engaged with the holes 101 to connect the connection unit 2 to the base 1. When disassembling the connection unit 2 from the base 1, the user pushes the two protrusions 202 inward so that the two protrusions 202 are removed from the holes 101, and the connection unit 2 can be removed from the base 1. Therefore, the connection unit 2 and the base 1 can be easily cleaned.

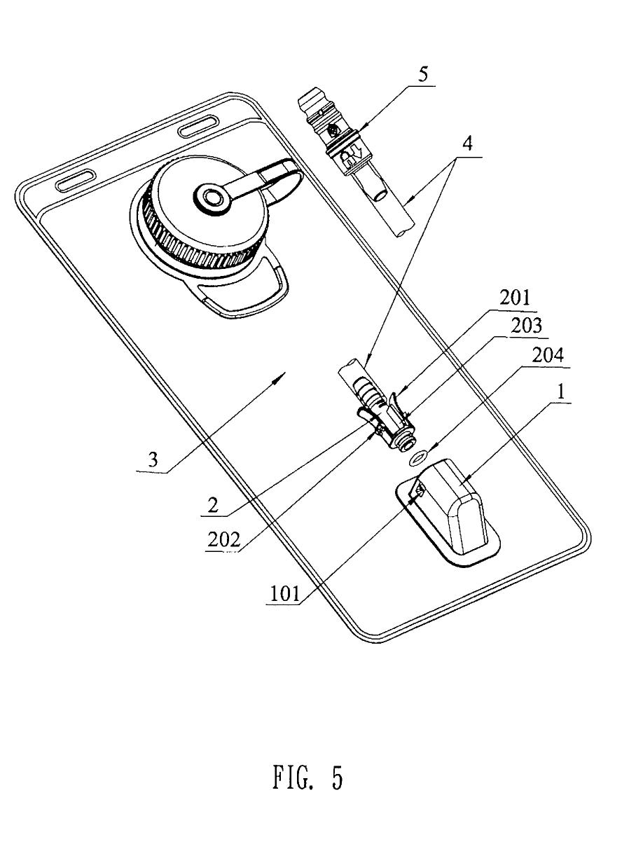

As shown in FIGS. 1 to 5, the water withdrawing device is connected to a water bag 3 to form the hydro pack which further has a hose 4 and a valve 5. The water withdrawing device comprises a base 1 fixed to the water bag 3 and a connection unit 2 which has a connection mechanism located at the first end thereof and the first end of the connection unit 2 is connected to the base 1 by the connection mechanism. The connection mechanism allows the user to assemble the water withdrawing device to the water bag 3 or remove the water withdrawing device from the water bag 3 easily. The connection unit 2 has two resilient plates 201 located on two sides thereof and each resilient plate 201 has a first end fixed to the connection unit 2. A second end of each resilient plate 201 is a curved end and extends outward so as to be deformed inward. Each resilient plate 201 has a triangular protrusion 202 on the outside thereof. The base 1 has a reception recess for receiving the first end of the connection unit and two holes 101 are defined through the wall of the reception recess so that the two protrusions 202 on the two resilient plates 201 are engaged with the holes 101. When assembling, the two resilient plates 201 can be pushed inward so that the first end of the connection unit 2 is inserted into the reception recess of the base 1. When releasing the resilient plates 201, the two protrusions 202 on the two resilient plates 201 are engaged with the holes 101 to connect the connection unit 2 to the base 1. The connection between the base 1 and the connection unit 2 is more durable and strong than the conventional threaded connection. When disassembling the connection unit 2 from the base 1, the user pushes the two protrusions 202 inward so that the two protrusions 202 are removed from the holes 101, and the connection unit 2 can be removed from the base 1. Therefore, the connection unit 2 and the base 1 can be easily cleaned.

There are two boards 203 extending from the connection unit 2 and located alternatively to the resilient plates 201. The base 1 has two slots 102 with which the two boards 203 are removably engaged. By the engagement of the boards 203 and the slots 102, the connection unit 2 can be positioned and then be firmly inserted into the base 1. The base 1 is a casing and the outlet of the water bag 3 is a circular hole and defined in the casing. The first end of the connection unit 2 is a hollow and tubular portion which is engaged with the outlet so that the liquid in the water bag 3 flows to the connection unit 2 via the outlet. The connection unit 2 has a groove defined in the outside of a first end thereof and a seal ring 204 is engaged with the groove. The first end of the connection unit 2 is inserted into the base 1 and the seal ring 204 seals the inner periphery of the outlet of the base 1. There are threads are defined in the outside of a second end of the connection unit 2 and a hose 4 can be securely mounted to the threads so as to be connected with the connection unit 2.

When installing the connection unit 2 to the base 1, the user pushes the two resilient plates 201 inward and the first end of the connection unit 2 is inserted into the reception recess of the base 1. When releasing the resilient plates 201, the two protrusions 202 on the two resilient plates 201 are engaged with the holes 101 to connect the connection unit 2 to the base 1. When disassembling the connection unit 2 from the base 1, the user pushes the two protrusions 202 inward so that the two protrusions 202 are removed from the holes 101, and the connection unit 2 can be removed from the base 1. Therefore, the connection unit 2 and the base 1 can be easily cleaned.

The water withdrawing device is more durable and reliable, and the connection unit 2 can be easily assembled to the base 1 and easily removed from the base 1 for cleaning purpose.

While we have shown and described the embodiment in accordance with the present invention, it should be clear to those skilled in the art that further embodiments may be made without departing from the scope of the present invention.

What is claimed is:

1. A water withdrawing device for a water bag, comprising:
a base adapted to be fixed to the water bag;
a connection unit having two resilient plates located on two sides thereof, each resilient plate having a first end fixed to the connection unit and a second end of each resilient plate being a curved end and extending outward, each resilient plate having a protrusion on an outside thereof, the base having holes with which the two protrusions on the two resilient plates are engaged.

2. The device as claimed in claim 1, wherein two boards extend from the connection unit and located alternatively to the resilient plates, the base has two slots with which the two boards are engaged.

3. The device as claimed in claim 1, wherein the connection unit has a groove defined in an outside of a first end thereof and a seal ring is engaged with the groove, the first end of the connection unit is inserted into the base and the seal ring seals an inner periphery of the base.

4. The device as claimed in claim 3, wherein threads are defined in the outside of a second end of the connection unit.

5. A hydro pack comprising:
a water bag for receiving liquid therein;
a water withdrawing device connected to the water bag and comprising a base fixed to the water bag, and
a connection unit having two resilient plates located on two sides thereof, each resilient plate having a first end fixed to the connection unit and a second end of each resilient plate being a curved end and extending outward, each resilient plate having a protrusion on an outside thereof, the base having holes with which the two protrusions on the two resilient plates are engaged.

6. The device as claimed in claim 5, wherein two boards extend from the connection unit and located alternatively to the resilient plates, the base has two slots with which the two boards are engaged.

7. The device as claimed in claim 5, wherein the connection unit has a groove defined in an outside of a first end thereof and a seal ring is engaged with the groove, the first end of the connection unit is inserted into the base and the seal ring seals an inner periphery of the base.

8. The device as claimed in claim 7, wherein threads are defined in the outside of a second end of the connection unit.
